(19) United States
(12) Patent Application Publication
(10) Pub. No.: US 2006/0248595 A1
(43) Pub. Date: Nov. 2, 2006

(54) Reproducing encrypted content using region keys

(75) Inventors: Declan Patrick Kelly, Shanghai (CN); Wiebe De Haan, Eindhoven (NL); Wilhelmus Jacobus Van Gestel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/567,212

(22) PCT Filed: Jul. 30, 2004
(86) PCT No.: PCT/IB04/51339

§ 371 Date: Feb. 3, 2006

(30) Foreign Application Priority Data
Aug. 8, 2003 (EP) 03102486.2

(51) Int. Cl. H04L 9/32

(52) U.S. Cl. 726/27

(57) ABSTRACT

A reproducing apparatus (1) reproduces content stored in encrypted form on a record carrier (2). The record carrier (2) further stores a carrier region code (RCC) indicating in which region content shall be allowed to be reproduced and an encrypted region key (RK) for decrypting content, in order to make it more difficult to hack a reproducing apparatus (1) for it to play record carriers having a wrong region code. The reproducing apparatus (1) has a region code storage (10) for storing a device region code (RCD), and a device key storage (11) for storing a device key (DK), which device key (DK) is different for all regions. The reproducing apparatus (1) reads a carrier region code (RCC) from the record carrier (2), checks if the carrier region code (RCC) matches the device region code (RCD), reads the encrypted region key (RK) from the record carrier (2), decrypts the encrypted region key (RK) using said device key (DK) in case the carrier region code (RCC) matches the device region code (RCD), reads the encrypted content from the record carrier (2), decrypts the encrypted content using the decrypted region key (RCD) and outputs the decrypted content.

The present invention relates to a reproducing apparatus and a corresponding reproducing method for reproducing content stored in encrypted form on a record carrier, said record carrier further storing a carrier region code indicating in which region said content shall be allowed to be reproduced and an encrypted region key for decrypting said content. Further, the present invention relates to a record carrier storing content in encrypted form which can be reproduced by such a reproducing apparatus and method. Still further, the present invention relates to a computer program for implementing said reproducing method.

DVD-video discs and DVD-players contain region codes. Such discs can only be played back and the content stored therein can only be reproduced if a carrier region code stored on the disc matches the device region code stored in the player. This allows movie studios to control the timing of DVD releases. In practice, however, many players can be easily made to play discs from any region so that the current system of controlling the timing of DVD releases does not work properly.

New copy protection systems allow the possibility of revoking devices. Once a device is revoked, record carriers manufactured after this revocation time will not play in this device. To support device revocation, each disc contains an enabling key block (EKB). Only authorized, i.e. non-revoked, drives are able to calculate the required enabling key block key from this EKB and their device key stored in the drive. Devices can thus be easily revoked by removing the corresponding entry from the EKB. Such a copy protection system is, for instance, described in US 2002/0136411 A1.

It is an object of the present invention to provide a reproducing apparatus and a corresponding reproducing method as well as a record carrier which provide a higher security against hacking, i.e. which make it more difficult to make a player region code free.

This object is achieved according to the present invention by a reproducing apparatus for reproducing content stored in encrypted form on a record carrier, said record carrier further storing a carrier region code indicating in which region said content shall be allowed to be reproduced and an encrypted region key for decrypting said content, said reproducing apparatus comprising:
a region code storage means for storing a device region code,
a device key storage means for storing a device key, said device key being different for all regions,
a carrier region code reading means for reading said carrier region code from said record carrier,
a region code check unit for checking if said carrier region code matches said device region code,
a region key reading means for reading said encrypted region key from said record carrier,
a region key decryption means for decrypting said encrypted region key using said device key in case said carrier region code matches said device region code,
a content reading means for reading said decrypted content from said record carrier,
a content decryption means for decrypting said encrypted content using said decrypted region key and
output means for outputting said decrypted content.

The present invention is based on the idea to link the use of region codes to a copy protection system. It is proposed to use the way in which device revocation of a copy protection system is implemented for implementing region codes in a very secure way. A record carrier having a wrong carrier region code will thus not play in a reproducing apparatus (player) in the same way in which a revoked player can not play a new record carrier.

One main aspect of the proposed invention is that devices in different regions store a different device key. Then, record carriers for a particular region will not include entries, in particular a carrier region code, for devices from other regions. According to the present invention, the region code is checked first, i.e. it is checked if the carrier region code stored on the record carrier matches a device region code stored in the reproducing apparatus. Only if this check gives a positive result, a region key stored also on the record carrier is decrypted using the device key, which encrypted region key is finally used to decrypt encrypted content read from the record carrier. With this solution there will be no easy hack to allow playing of record carriers having region codes not matching the device region code. Further, making the player region code free would be equivalent to breaking a copy protection system.

Preferred embodiments of the invention are defined in the dependent claims. According to an advantageous embodiment is proposed that at least two encrypted region keys are stored on the record carrier and that at least two device keys are stored in the device key storage means of the apparatus. Furthermore, a key selection means is provided for selecting an encrypted region key from the at least two encrypted region keys and for selecting a device key from the at least two device keys using the carrier region code and the device region code. For decryption of the selected encrypted region key the selected device key will then be used. According to this embodiment, devices for different regions may store one or more identical device keys; however, at least one device key is different for devices from different regions. By use of the carrier region code and the corresponding device region code for selection of the correct device key an additional level of security against hacking is provided according to this embodiment. Such an embodiment is preferably used for a small number of regions (e.g. less than 10 regions).

In a further embodiment is proposed that the carrier region code comprises one or more tags, each tag including a revocation information indicating regions from which regions record carriers are allowed for reproduction. Such tags allow the use of a tree-structure as proposed according to still a further embodiment, said tree structure representing all possible regions which are at least partly combined into region groups at a node. In this tree structure to each node a corresponding tag of said carrier region code is assigned enabling, together with the device region code, the selection of the appropriate device key and the corresponding encrypted region key. The use of such a tree structure, which preferably comprises at least two hierarchical layers and has a number of branches, in particular three branches, branching off from each node, enables a reduction of the number of tags to be used compared to a structure in which for each region a carrier region code would have to be stored on the record carrier. Furthermore, the tree structure also enables a reduction of the number of device keys to be stored in the reproducing apparatus if, as proposed according to a further embodiment, a number of device keys are assigned to each node of the tree, where at least one device key is provided for each branch of a node which is not assigned to all other branches of said node. In the simplest case, for three branches three different device keys are assigned to the node, while in a more advanced case three device keys are assigned to each branch of a node having three branches, wherein one device key of each branch is also assigned to only one further branch.

In the straightforward embodiment each node has three different device keys. The device contains only the device key from the used branch. The number of device keys stored in the device is then (N+1) with N being the number of layers; there is one key for the root.

In the advanced embodiment, three device keys are assigned to each node and the total number of different device keys per node is 6. Some keys are shared by the branches. The total number of device keys for a certain device is (3*N+1). The advantage of this embodiment is the following: some device keys are shared by two branches. If one of the branches is revoked then the two others need only one (shared) key. This means that the number of encrypted region keys on the keys is halved. The number of device keys in a device increases, but the total number remains small. On the other hand, the number of encrypted region keys on the record carrier is reduced considerably. In the lower layer (of a number of layers) the number of nodes is very high (millions).

Thus, according to this advanced embodiment the structure is the same as the general encryption scheme, while the advantage of the above described straightforward embodiment is that less encrypted region keys are needed. The straightforward embodiment is preferably used for a higher but not too high number of regions (e.g. 10-30 regions); the advanced embodiment can be used for a large number of regions (e.g. more than 30 regions).

A reduction of the number of device keys to be stored in the device key storage means is in particular achieved when only device keys assigned to nodes in the chain of the hierarchical tree from the top layer to the bottom layer are stored, the bottom layer representing the different regions. Thus, for instance, in the simplest case for a three-layer structure, only three device keys need to be stored in the reproducing apparatus.

According to a further embodiment each tag includes a termination information indicating if there are further tags assigned to nodes of branches, branching off from the node to which said tag is assigned, in lower hierarchical layers. This also enables a reduction of the number of tags to be stored on a record carrier.

Known copy protection systems use a secure chip to implement the copy protection which needs to be licensed. If region codes are enforced by the secure chip as is proposed according to a further embodiment according to which the region code storage means, the device key storage means, the region code check unit and the region key decryption means are embedded in a separate semiconductor device, it will be very difficult for a manufacturer to avoid enforcing the region code. Moreover, for each region a different recording mode key can be chosen or derived from the same number so that a record carrier from the wrong region will be not be playable. Because this encryption is preferably implemented in the secure chip the manufacturer can not avoid the region code rules.

In a still further embodiment it is proposed that, preferably in this semiconductor device, a counter is used to count the number of times the device region code is changed. After a certain number the device region is set to a default value and can, preferably, not be changed anymore by the consumer. In this way, the licensor can enforce the region code rules and does not need to rely on the manufacturer.

The invention will now be explained in more detail with reference to the drawings in which

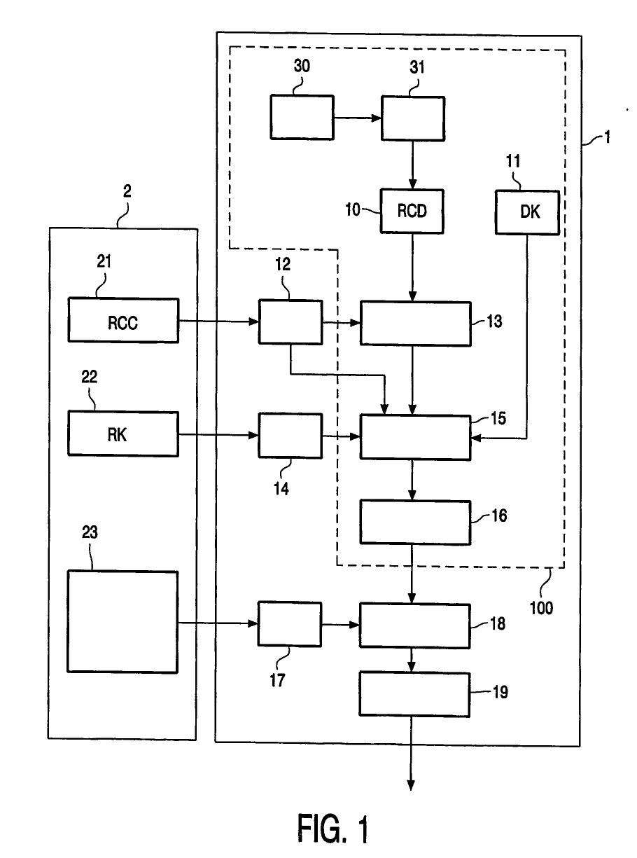

FIG. 1 schematically shows a block diagram of a reproducing device and a record carrier according to the present invention,

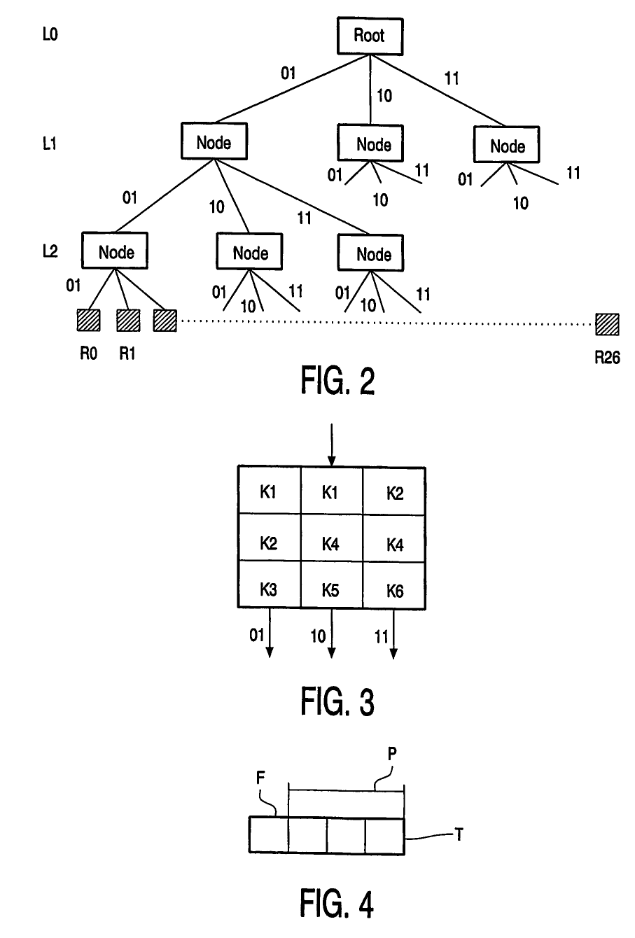

FIG. 2 shows a tree structure used according to the present invention,

FIG. 3 shows an array of device keys assigned to a node in the tree structure of FIG. 2,

FIG. 4 shows the content of a tag assigned to each node in the tree structure of FIG. 2,

FIGS. 5 to 8 illustrate different examples by use of the tree structure shown in FIG. 2,

FIG. 9 shows a different array of device keys assigned to a node in the tree structure of FIG. 2 and

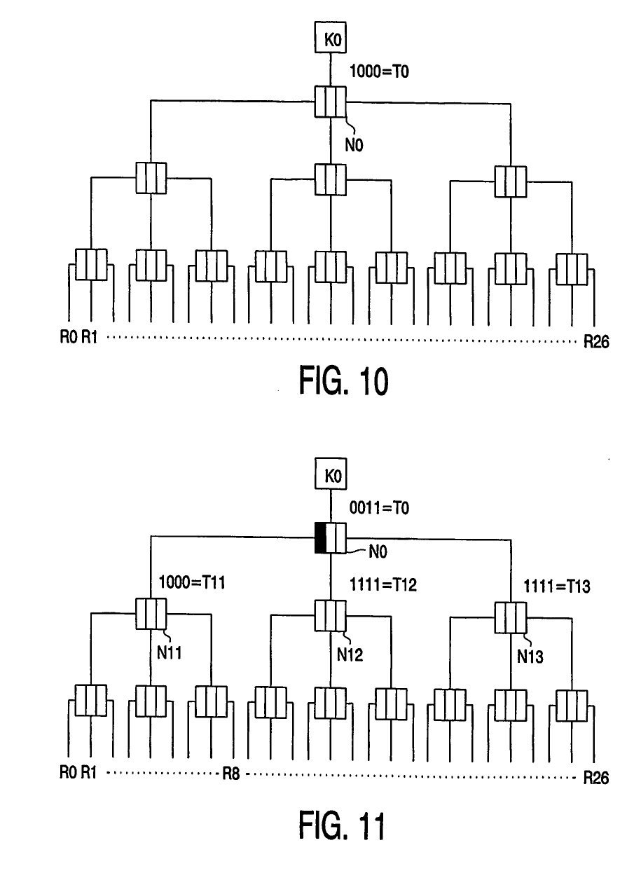

FIGS. 10, 11 illustrate further examples by use of the tree structure shown in FIG. 2 and the array of device keys shown in FIG. 9.

A block diagram of a reproducing apparatus 1 and a record carrier 2 according to the present invention are shown in FIG. 1. The record carrier, for instance a CD, DVD or BD disc, comprises a carrier region code RCC (Region Code Carrier) stored in a region code memory 21, at least one encrypted region key RK stored in a region key memory 22 and encrypted content, for instance audio data, video data, software or any other kind of information, are stored in a content memory 23. In order to reproduce the encrypted content a suitable reproducing apparatus 1, for instance a suitable DVD drive, is to be used. In order to control which record carriers 2 can be reproduced in which regions appropriate means are provided on the record carrier 2 as well as in the reproducing apparatus 1 which work together in the way explained in the following.

The reproducing apparatus 1 stores a device region code RCD (Region Code Device), also called device-ID, in a device region code storage means 10 and at least one device key DK in a device key storage means 11. To check if the record carrier 2 is allowed to be reproduced by this particular reproducing apparatus 1 a carrier region code reading means 12 reads the carrier region code RCC from the record carrier 2 and provides it to a region code check unit 13 which checks if the carrier region code RCC matches the device region code RCD. If this check gives a positive result the at least one region code RK is read from the record 2 carrier by a region key reading means 14 from which it is provided to a key selection means 15. Therein, by use of the device region code RCD and the carrier region code RCC, both either provided via the check unit 13 or directly from the reading means 12 or the storage means 10, respectively, the encrypted region key RK is selected from the set of encrypted region keys for decryption in region key decryption means 16. Furthermore, in the selection unit 15 appropriate device key DK which shall be used for decryption of the selected encrypted region key RK in the decryption means 16 is selected.

The decrypted region key obtained by the decryption in decryption means 16 will then be used by a content decryption means 18 for decryption of encrypted content read from the record carrier 2 by content reading means 17. Further keys which are not shown here, such as a recording key unique for a particular file, a media key unique for this particular record carrier 2 and a block key unique for a particular part of a file, can be additionally be used for decryption of the encrypted content. The decrypted content is finally outputted from the reproducing apparatus 1 by output means 19.

In order to make it more difficult for a manufacturer to avoid enforcing other region code system proposed by this invention, the means 10, 11, 13, 15 and 16 are preferably embedded in a separate semiconductor device 100. This semiconductor device 100 can be traded separately but must be used in order to reproduce the record carrier 2. Thus, a manufacturer can not avoid the region code rules.

Further, it is proposed that in the semiconductor device 100 a counter 30 is used to count the number of times the device region code RCD is changed. After a certain number the device region code RCD is set to a default code by a reset unit 31 so that it can not be changed anymore. In this way a licensor of the semiconductor device 100 can enforce the region code rules and does not need to rely on the manufacturer.

In the following, a particular embodiment of the invention will be explained in more detail by way of an example assuming that there are a maximum of 27 regions, for instance 27 different countries. In this example the addressing of the regions shall be made by use of a ternary tree as shown in FIG. 2. This tree represents the structure of the 27 regions R0, R1, . . . , R26 shown in the bottom row. In this example the tree comprises three different layers, a top layer L0 comprising the root, a middle layer L1 comprising three nodes and a bottom layer L2 comprising 9 nodes. From the root and from each node three branches branch off, to each of which a 2-bit address is assigned. Thus, each region, and further, each device provided for a particular region can be addressed by a 6-bit code which consists of the two-bit codes assigned to the branches in the chain from the root to this particular region. As an example, the address of region R5 is 01.10.10. Thus all devices in region R5 have device region code RCD=01.10.10.

In a particular embodiment there are 6 device keys DK associated which each node, but only 3 device keys are different for a device addressed by this node. The number of device keys in each device is for this example 7 device keys, i.e. three device keys from each of the two nodes and one device key for the root in the chain from the region to the root. An array of device keys associated with a node in this example is shown in FIG. 3. As can be seen branch 01 branching off from this node has device keys K1, K2, K3, branch 10 has device keys K1, K4, K5 and branch 11 has device keys K2, K4, K6. This means, that there is no device key that is common to all branches, but each device key is only assigned to two branches at maximum so that, in reverse, there is one device key for each branch which is not assigned to all other branches.

The selection which device key to use for decryption of an encrypted region key in the region key decryption means 16 is made by use of the carrier region code RCC and the device region code RCD. Preferably, the device region code RCD comprises a so-called tag information including one or more tags. An embodiment of such a tag T is shown in FIG. 4. According to this embodiment the tag comprises 4 bits, a revocation pattern P of 3 bits and a termination flag F of 1 bit. The revocation pattern P represents revoked regions from the branches branching off from the node to which this tag T is assigned. Each of the three bits of the revocation patterns P is assigned to one of the three branches. A “1” means revoked, a “0” means not revoked. The termination flag F indicates that there is no revoked region in the branches branching off from this node. A “1” means that there are no more tags assigned to nodes in lower layers in any branches directly or indirectly branching off from the present node.

Only from the relevant, i.e. revoked and not terminated, nodes the tag information is stored as part of the carrier region code CRD on the record carrier 2. The tag information is used and evaluated by the selection unit 15 to determine which device key DK has to be used for decryption of the encrypted region code RK. Thus, encrypted region keys which are not needed are not stored on the record carrier 2.

Particular examples using the structure of the tree shown in FIG. 2, the array of device keys shown in FIG. 3 and tags shown in FIG. 4 are illustrated in FIGS. 5 to 8. In the example shown in FIG. 5 only one tag T0, i.e. tag “1000” assigned to node N0 in the top layer, is stored on the record carrier. The device key of the root (K0) is taken to decrypt the encrypted region key. Since the termination flag F of the tag of node N0 indicates that there are no further tags assigned to any other nodes, no further tags need to be stored on the record carrier. Further, only one encrypted region key needs to be stored on the record carrier. In this particular example the record carrier can be reproduced in all regions since there are no regions revoked.

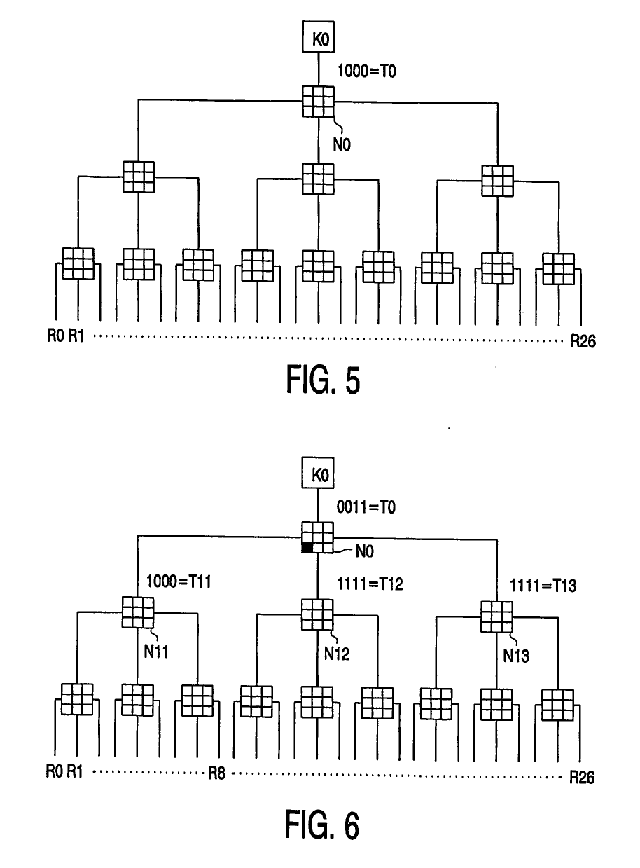

In the example shown in FIG. 6 the record carrier can only be reproduced in regions R0 to R8. There are 4 tags stored as carrier region code stored on the record carrier:

tag T0 (0011) of node N0 indicating that no revoked regions are in the left branch and that there are revoked regions in the middle and the right branch;

tag T11 (1000) of node N11 indicating that there are no regions revoked in the branches;

tags T12 and T13 (1111) of nodes N12 and N13 indicating that all regions are revoked in the branches.

It is thus sufficient to store one encrypted region key on the record carrier. This encrypted region key is decrypted with the device key K3 of node N0. This node N0 is derived from the tag information. From tags T12 and T13 it is known that all regions in this part of the tree are revoked, so that there is no valid device key for devices in these regions. Only device key K3 (see FIG. 3) of node N0 is used by the left branch and not by other branches branching off from node N0. All devices from regions R0 to R8 can use this device key.

In the example shown in FIG. 7 the record carrier can only be reproduced in regions R0 to R2. There are 7 tags stored on the record carrier:

tag T0 (0111) of node N0 indicating that all branches contain revoked regions;

tag T11 (0011) of node N11 indicating that there are no revoked regions in the left branch and that there are revoked regions in the middle and right branch;

tags T12, T13, T22, T23 (1111) of nodes N12, N13, N22, N23 indicating that all regions from the branches are revoked and

tag T21 (1000) of node N21 indicating that no regions from the branches are revoked. Also in this example it is sufficient to store one encrypted region key on the record carrier. This region key is decrypted with the device key K3 of node N11. This node N11 can be derived from the tag information. All devices from regions R0 to R2 can use this device key.

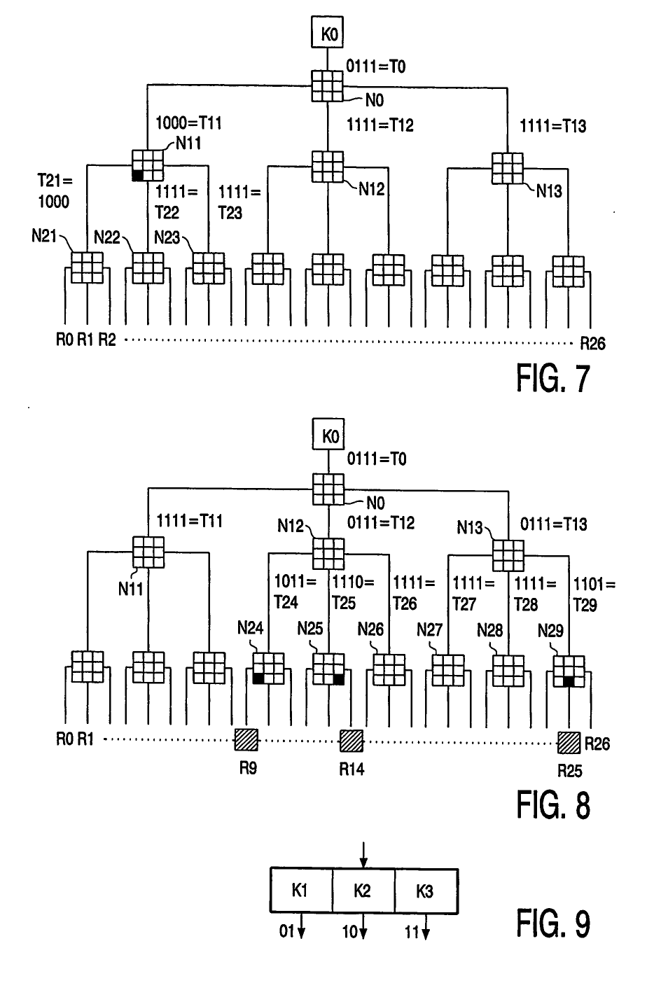

According to the example shown in FIG. 8 the record carrier can only be read in regions R9, R14 and R25. It is sufficient to store only three encrypted region keys on the record carrier. From these keys the correct one is selected by use of the tags and the device region key. The selected encrypted region key is decrypted using the device key from the corresponding node which is also derived from the tag information. There are 10 tags stored on the record carrier:

tag T0 (0111) of node N0 indicating that all branches contain revoked regions;

tags T11, T26, T27, T28 (1111) of nodes N11, N26, N27, N28 indicating that all regions from the branches are revoked;

tags T12, T13 (0111) of nodes N12, N13 indicating that all branches contain revoked regions;

tag T24 (1011) of node N24 indicating that the middle and right branches are revoked;

tag T25 (1110) of node N25 indicating that the left and middle branches are revoked; and

T29 (1101) of node N29 indicating that the left and right branches are revoked.

In the above examples an array of device keys comprising 6 different device keys as shown in FIG. 3 is used. Using such an embodiment each device can be individually revoked even if a high number of devices, for instance several millions, shall be individually addressed, which can be made by use of a large tree having a high number of layers (for instance 24 layers). If a lot of devices are revoked, then also a lot of encrypted region keys need to be stored on the disc. By using 6 device keys as described above, this number of encrypted region keys can be reduced. For instance, if only one branch is revoked in a node, then there is only one encrypted region key stored on the disc corresponding to the device key K1, K2 or K4.

However, in a more simple embodiment it is also possible to use only three device keys per node as shown in FIG. 9. In this embodiment to each branch a single device key is assigned. If branch 01 is revoked then the encrypted keys K2 and K3 are stored on the record carrier; if branch 10 is revoked then encrypted keys K1 and K2 are stored on the record carrier; if branch 11 is revoked then the encrypted keys K1 and K2 are stored on the record carrier; if branches 01 and 10 are revoked then the encrypted key K3 is stored on the record carrier; if branches 01 and 11 are revoked then the encrypted key K2 is stored on the record carrier; and if branches 11 and 10 are revoked then the encrypted K1 is stored on the record carrier. Two examples of the tree structure using the array of device keys shown in FIG. 9 and tags shown in FIG. 4 are illustrated in FIGS. 10 and 11 which allow the record carrier to be read in all regions (FIG. 10) or to be read in all regions R0 to R8 (FIG. 11).

According to the invention a device revocation system is used to implement region codes. A record carrier having the wrong region code will not play in the reproducing apparatus in the same way that a revoked reproducing apparatus can not play a new disc. To achieve this it is mainly proposed that devices in different regions have different device keys. Record carriers for a particular region will then not include entries for devices from other regions. With the proposed solution it is not easy to hack a device to allow playing of discs having other region codes, but making the device region code free will be equivalent to breaking a copy protection system.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Reproducing apparatus (1) for reproducing content stored in encrypted form on a record carrier (2), said record carrier (2) further storing a carrier region code (RCC) indicating in which region said content shall be allowed to be reproduced and an encrypted region key (RK) for decrypting said content, comprising:
a region code storage means (10) for storing a device region code (RCD),
a device key storage means (11) for storing a device key (DK), said device key (DK) being different for all regions,
a carrier region code reading means (12) for reading said carrier region code (RCC) from said record carrier (2),
a region code check unit (13) for checking if said carrier region code (RCC) matches said device region code (RCD),
a region key reading means (14) for reading said encrypted region key (RK) from said record carrier (2),
a region key decryption means (16) for decrypting said encrypted region key (RK) using said device key (DK) in case said carrier region code (RCC) matches said device region code (RCD),
a content reading means (17) for reading said encrypted content from said record carrier (2),
a content decryption means (18) for decrypting said encrypted content using said decrypted region key and
output means (19) for outputting said decrypted content.

2. Reproducing apparatus as claimed in claim 1,
wherein said record carrier (2) stores at least two encrypted region keys (RK),
wherein said device key storage means (11) is adapted for storing at least two device keys (DK),
wherein said reproducing apparatus (1) further comprises a key selection means (15) for selecting an encrypted region key (RK) from said at least two encrypted region keys and for selecting a device key (DK) from said at least two device keys using said carrier region code (RCC) and said device region code (RCD), and
wherein said region key decryption means (16) is adapted for decrypting said selected encrypted region key using said selected device key (DK).

3. Reproducing apparatus as claimed in claim 1, wherein said carrier region code (RCC) comprises one or more tags (T), each tag (T) including a revocation information (P) indicating regions from which record carriers are allowed for reproduction.

4. Reproducing apparatus as claimed in claim 3, wherein said tags (T) are assigned to different nodes (N) of a tree structure representing all possible regions which are at least partly combined into region groups at a node.

5. Reproducing apparatus as claimed in claim 4, wherein said tree structure comprises at least two hierarchical layers (L0, L1) and wherein each node (N) has a number of branches, in particular three branches.

6. Reproducing apparatus as claimed in claim 5, wherein a number of device keys (DK) are assigned to each node (N), said number comprising at least one device key (DK) for each branch of said node (N) which is not assigned to all other branches of said node (N).

7. Reproducing apparatus as claimed in claim 6, wherein said device key storage means (11) are adapted for storing only device keys (DK) assigned to nodes (N) in the chain of the hierarchical tree from the top layer (L0) to the bottom layer (L2).

8. Reproducing apparatus as claimed in claim 5, wherein each tag (T) includes a termination information (E) indicating if there are further tags assigned to nodes of branches, branching off from the node to which said tag (T) is assigned, in lower hierarchical layers.

9. Reproducing apparatus as claimed in claim 1, wherein said region code storage means (10), said device key storage means (11), said region code check unit (13) and said region key decryption means (16) are embedded in separate semiconductor device (100).

10. Reproducing apparatus as claimed in claim 9, further comprising a counter (30) for counting the number of times the device region code (RCD) is changed and a reset means (31) for resetting the device region code (RCD) to a default value if a predetermined number of changes has been made.

11. Reproducing method for reproducing content stored in encrypted form on a record carrier (2), said record carrier (2) further storing a carrier region code (RCC) indicating in which region said content shall be allowed to be reproduced and an encrypted region key (RK) for decrypting said content, comprising the steps of:
reading said carrier region code (RCC) from said record carrier (2),
checking if said carrier region code (RCC) matches a device region code (RCD) stored in a reproduction apparatus (1),
reading said encrypted region key (RK) from said record carrier (2),
decrypting said encrypted region key (RK) using a device key (DK) stored in said reproduction apparatus (1) in case said carrier region code (RCC) matches said device region code (RCD),
reading said encrypted content from said record carrier (2),
decrypting said encrypted content using said decrypted region key (RCD) and
outputting said decrypted content.

12. Record carrier (2) storing
content in encrypted form for reproduction by reproducing apparatus (1),
a carrier region code (RCC) indicating in which region said content shall be allowed to be reproduced and
an encrypted region key (RK) for decrypting said content,
wherein during reproduction
said carrier region code (RCC) is used to check if said carrier region code (RCC) matches a device region code (RCD) stored in a reproduction apparatus (1),
said encrypted region key (RK) is decrypted using a device key (DK) stored in said reproduction apparatus (1) in case said carrier region code (RCC) matches said device region code (RCD), and
said encrypted content is decrypted using said decrypted region key.

13. Computer program comprising program code means for causing a computer to perform the steps of the method as claimed in claim 11 when said computer program is executed on a computer.
